(19) United States
(12) Patent Application Publication
(10) Pub. No.: US 2025/0238784 A1
(43) Pub. Date: Jul. 24, 2025

(54) GENERATING GIFT CARDS USING NATURAL LANGUAGE PROCESSING

(71) Applicant: BLINKSKY, INC., Alpharetta, GA (US)

(72) Inventors: Mark Chambers, Alpharetta, GA (US); Yasmine Williams, Alpharetta, GA (US)

(21) Appl. No.: 19/032,724

(22) Filed: Jan. 21, 2025

Related U.S. Application Data
(60) Provisional application No. 63/622,814, filed on Jan. 19, 2024.

(51) Int. Cl. G06Q 20/34; G06F 40/58; G10L 15/183; G10L 15/22; G10L 15/30

(52) U.S. Cl. CPC G06Q 20/351; G06F 40/58; G10L 15/183; G10L 15/22; G10L 15/30

(57) ABSTRACT

The disclosed technology may include a system including one or more processors and memory coupled with the one or more processors, the memory storing executable instructions that when executed by the one or more processors cause the one or more processors to effectuate operations comprising: receiving an audio input comprising a natural language request from a user for a digital gift card, determining request information based on the audio input, determining, by querying a database of available gift cards, a proposed gift card based on the request information, generating a digital representation of the proposed gift card, and transmitting the digital representation of the gift card to a recipient device.

### CROSS-REFERENCE TO RELATED APPLICATIONS

This application claims the benefit of, and priority to, U.S. Provisional Patent App. No. 63/622,817, filed on Jan. 19, 2024 and entitled “GENERATING GIFT CARDS USING NATURAL LANGUAGE PROCESSING,” the disclosure of which is incorporated by reference in its entirety as if the same was fully set forth herein.

### TECHNICAL FIELD

The present disclosure relates generally to systems and methods for generating gift cards and, more particularly, to distributing gift cards by interpreting natural language in electronic communications.

### BACKGROUND

The digital age of commerce has made distributing gift cards incredibly ubiquitous. Gift cards are widely used for their convenience and versatility, serving as a means for individuals to gift monetary value in a targeted and meaningful way. However, the process of acquiring and distributing gift cards remains fraught with inefficiencies and challenges. Conventional systems often require users to navigate multiple platforms, manage various accounts, and repeatedly provide sensitive payment information, creating unnecessary friction and potential security concerns. For example, purchasing gift cards from multiple sources requires creating various accounts and providing sensitive billing information to multiple platforms. Additionally, there is no streamlined way to efficiently distribute gift cards to a particular recipient. Furthermore, there are no known techniques that are capable of generating gift cards based on natural language-based interactions.

Therefore, there is a long-felt but unresolved need for a system or method that bridges the gap between user intent expressed in natural language and the efficient generation and delivery of digital gift cards. Such a system would not only reduce the complexity and time associated with gift card transactions but also enhance personalization and accessibility, thereby addressing long-standing inefficiencies in this domain.

### BRIEF SUMMARY OF THE DISCLOSURE

Briefly described, and according to one example, aspects of the present disclosure generally relate systems and methods for generating one or more gift cards by interpreting natural language in an electronic communication and sending the gift cards to one or more recipients.

The disclosed technology may include a client device and a computing environment, which are in data communication across a network. The disclosed technology may include systems and methods for generating and sending gift cards to a recipient based on a natural language input. For example, the client device may include a cell phone with a display, microphone, and speaker. The client device may include a client application that includes a user interface. The user interface may include digital representations of all available gift cards and a virtual representation (e.g., audio and/or visual) of a non-human chat assistant. The computing environment and/or the client device may output a request requesting the client to detail their desired gift card and/or any other associated information. The client may speak into the client device and the client device may generate and audio recording input. For example, the audio recording input may include the following request: “I would like to send my friend Alex a TaylorMade gift card of 150 dollars. Please write him a message of three sentences congratulating him on passing the Patent Bar. His email address is Alex@notarealemail.com.” The client device may send the audio recording input to the computing environment for further processing. The computing environment may employ one or more large language models (LLMs) to process the audio recording input to determine request information. The request information may include but is not limited to the requested gift card, the requested amount, the recipient's address, and/or the desired message.

The computing environment employing the LLM may determine if there are any errors associated with the request (e.g., the gift card is not available, the amount is invalid, the address is unreachable, the message include sensitive information or crude requests, etc.). If the computing environment determines that there is an error, the computing environment may generate an audio response detailing the error and a request for the client to send a subsequent audio recording input detailing a correction to the error. If the computing environment determines that there is no error, the computing environment may request the client to approve the request and send the gift card to the recipient. The computing environment may display (e.g., simultaneously) a digital rendition of the requested gift card, the requested message, the desired amount, and/or the recipient's address while confirming the request with the client. On confirmation, the computing environment may automatically send the digital gift card to the recipient.

These and other aspects, features, and benefits of the claimed invention(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE DRAWINGS

Reference will now be made to the accompanying drawings, which are not necessarily drawn to scale.

FIG. 1 illustrates a networked environment, according to one example of the present disclosure;

FIG. 2 illustrates a process flow diagram for generating one or more gift cards, according to one example of the present disclosure;

FIG. 3 illustrates a flowchart of a process for sending one or more gift cards, according to one example of the present disclosure;

FIG. 4 illustrates a schematic of an exemplary device according to various embodiments of the present disclosure; and

FIG. 5 illustrates an exemplary diagrammatic representation of a machine in the form of a computer system according to various embodiments of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

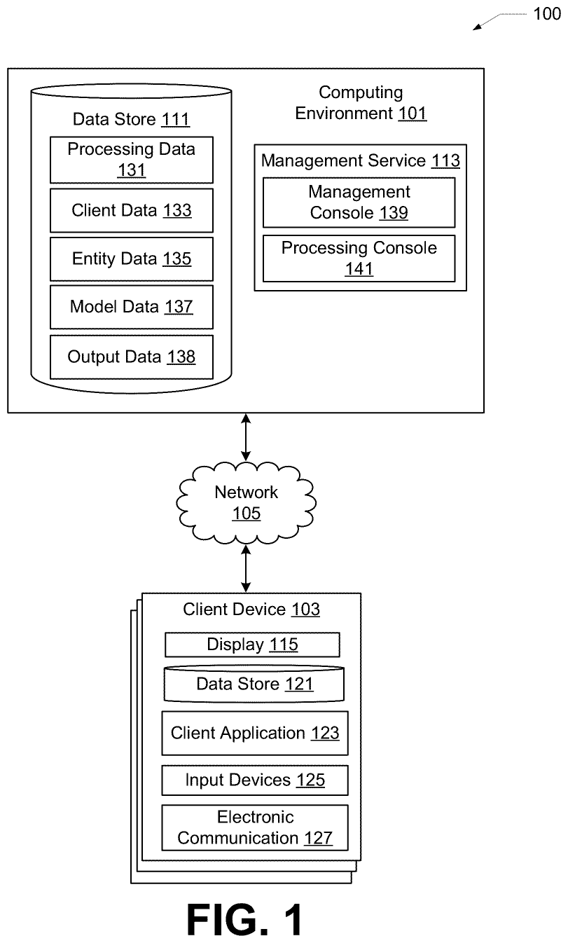

Referring now to the figures, for the purposes of example and explanation of the fundamental processes and components of the disclosed apparatuses, systems, and methods, reference is made to FIG. 1, which illustrates an example networked environment 100. As will be understood and appreciated, the networked environment 100 shown in FIG. 1 represents merely one approach or example of the present concept, and other aspects are used according to various examples of the present concept.

The networked environment 100 may include a computing environment 101 and a client device 103, which may be in data communication with each other via a network 105. The network 105 may include, for example, the Internet, intranets, extranets, wide area networks (WANs), local area networks (LANs), wired networks, wireless networks, or other suitable networks, etc., or any combination of two or more such networks. For example, the network 105 may include satellite networks, cable networks, Ethernet networks, Bluetooth networks, Wi-Fi networks, NFC networks, and other types of networks.

The computing environment 101 may include, for example, a server computer or any other system providing computing capability. Alternatively, the computing environment 101 may employ more than one computing device that may be arranged, for example, in one or more server banks, computer banks, or other arrangements. Such computing devices may be located in a single installation or may be distributed among many different geographical locations. For example, the computing environment 101 may include one or more computing devices that together may include a hosted computing resource, a grid computing resource and/or any other distributed computing arrangement. In some cases, the computing environment 101 may correspond to an elastic computing resource where the allotted capacity of processing, network, storage, or other computing-related resources may vary over time.

As discussed in further detail herein, the computing environment 101 of the networked environment 100 may generate one or more electronic gift cards by analyzing the natural language found in an electronic communication 127. The electronic communication 127 may include any digital message format used to convey a request, such as an email, text message, voice recording, voicemail, video message, social media post, or a statement in an online chat or forum. For example, if a client (also referred to herein as a user) would like to send a recipient a gift card, the client may employ their respective client device 103 to draft an email (e.g., functioning as the electronic communication 127). In the email, the client may specify, “I would like to send Wendy, at 123-456-7890, a 100-dollar Amazon gift card.” The client may send the email to a processing address. The computing environment 101 may receive the email from the processing address and may process the natural language within the email to generate a 100-dollar Amazon gift card. On creating the 100-dollar Amazon gift card, the computing environment 101 may send the 100-dollar Amazon gift card to the cellphone number stated in the email (123-456-7890).

The computing environment 101 may process any particular type of natural language sent through one or more electronic communications 127. For example, the computing environment 101 may process text sent through an email. In another example, the computing environment 101 may process text sent through a text message. In yet another example, the computing environment 101 may process a voice message sent during a phone call. In yet another example, the computing environment 101 may process a voice message sent over text. In yet another example, the computing environment 101 may process a video sent through a video messaging app. The computing environment 101 may process any particular electronic communication 127 (text, email, video, voice recording, real-time speech) that includes some form of natural language (e.g., text and/or speech).

The computing environment 101 may process natural language received as a voice message. For example, the computing environment 101 may receive in real-time an electronic communication 127 in the form of a voice recording that details a request to generate a gift card for an individual interested in golf. Continuing this example, the computing environment 101 may process the electronic communication 127 by extracting the natural language from the voice recording. On extracting the natural language from the voice recording, the computing environment 101 may compare the requested gift card type to a known set of gift cards. The computing environment 101 may identify one or more gift cards that best fit the parameters of the request (e.g., Golf Galaxy™, TaylorMade™, and/or FootJoy™ Gift cards). The computing environment 101 may generate a voice response and/or a visual display detailing the particular gift card options available. The client may subsequently send through the client device 103 a second electronic communication 127 in the form of a second voice recording detailing the client's selected gift card, their desired amount, a particular message for the recipient, and the address of the recipient. The computing environment 101 may analyze the second voice recording and generate a gift card and send the gift card to the particular recipient.

The computing environment 101 may employ one or more natural language processing techniques to analyze the natural language present in the electronic communication 127. For example, the computing environment 101 may employ a deep neural network to process natural language and determine various request factors associated with the electronic communication 127. The request factors may include but are not limited to gift card type, reason for sending gift card, recipient name, recipient address, recipient phone number, gift card amount, special request information, and/or multiple requests. The computing environment 101 may employ any particular model for determining the contents of the electronic communications 127. The computing environment 101 may employ any particular large language model (LLM) to process the electronic communications 127. For example, the computing environment 101 may employ an API service for interfacing with one or more LLMs to process requests and/or generate responses.

The computing environment 101 and/or the client device 103 may interface with a client application 123 of the client device 103 to receive electronic communications 127, send responses based on the electronic communications 127, and/or prompt particular actions within the user interface of the client application 123. For example, the client device 103 may receive a request to open the client application 123 and subsequently open the client application 123. On opening the client application 123, the client device 103 may surface a user interface that includes various visual representations of available gift cards and a visual representation of a virtual non-human chat assistant. The virtual non-human chat assistant may define a visual representation of the generated voice responses from the LLMs. The client device 103 may generate a request and verbally output the request through the client device 103 (e.g., through speakers and/or visually through the user interface) asking the client to provide information to send a particular gift card to a particular recipient. On receiving the electronic communication 127, the client device 103 and/or the computing environment 101 may process the electronic communication 127 to determine the particular requested gift card and other associated data. On determining the particular requested gift card, the client device 103 may employ an LLM to generate an audio response detailing the request and whether the client is ready to send the gift card. The client device 103 may surface through the user interface of the client application 123 a visual representation of the gift card, the requested amount, and/or the desired recipient address simultaneously with the audio response. The client device 103 may receive an electronic communication 127 in the form of a particular voice recording detailing a confirmation and approval of the request. The client device 103 and/or the computing environment 101 may subsequently process the particular voice recording and generate the gift card based on the perceived confirmation and approval from the client.

Functioning as the central computing source of the networked environment 100, the computing environment 101 may include a data store 111 and a management service 113. The data store 111 may function as the central data source of the computing environment 101, while the management service 113 may perform any particular computing requirement of the computing environment 101.

The data store 111 may store pertinent data necessary for various functionalities of the computing environment 101. The data stored in the data store 111 may include, for example, list of data, and potentially other data. The data store 111 may include but is not limited to processing data 131, client data 133, entity data 135, model data 137, and output data 138. Though discussed as individual modules, the data stored in the data store 111 may share similar data modules. For example, data stored in the processing data 131 may also be stored in the model data 137 and the entity data 135.

The processing data 131 may include any data necessary for processing electronic communications 127 with a particular form of natural language. For example, the processing data 131 may include but is not limited to text libraries, speech libraries, word embedding libraries, phrase libraries, sentence libraries, and/or any other data necessary for interpreting natural language in a particular electronic communication 127. The word embedding libraries of the processing data 131 may be represented using a multi-dimensional space. By using a multi-dimensional space, the computing environment 101 may represent words as vectors and plot the vectorized words in the multi-dimensional space. By representing the word embedding libraries as a multi-dimensional space, the computing environment 101 may determine similarities and differences between particular words, phrases, sentences, etc.

The client data 133 may include any data associated with one or more clients and their associated client devices 103. The client data 133 may include, for example, client name, client address, client billing address, client financial information, client preferences, client device information, client device data, and/or any other information associated with the client and their associated client device 103.

The entity data 135 may include any data associated with one or more entities issuing gift cards. For example, the entity data 135 may include but is not limited to entity names, entity addresses, entity financial information, gift card offerings, available entities, unavailable entities, and/or any other information associated with the one or more entities. The entity data 135 may vary over time. For example, the entity data 135 may increase in size as more entities employ the computing environment 101 for generating one or more gift cards. The entity data 135 may include various information used to identify an entity when the electronic communication 127 does not clearly state the particular entity in question. For example, the entity data may include synonymous names associated with the particular entity, common forms of misspelling the entity's name, and other forms of identifiable information associated with the particular entity. The entity data 135 may include the market of a particular entity, a description of the particular entity, the available gift card amounts and/or types, and/or any particular information associated with the particular company and/or gift card. For example, if a particular electronic communication 127 does not request a gift card associated with a specific entity, but rather a gift card that pertains to a particular hobby, field, etc., the computing environment 101 may compare the extracted request to the entity descriptions and/or entity markets to identify a set of gift cards that most similarly match the request.

The model data 137 may include any information used to process, train, and implement machine learning models/algorithms, artificially intelligent systems, deep learning models (e.g., neural networks), large language models, and/or natural language processing systems. Non-limiting examples of models stored in the model data 137 may include topic modelers, neural networks, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and combinations thereof. Neural networks may include but are not limited to uni- or multilayer perceptron, convolutional neural networks, recurrent neural networks, long short-term memory networks, auto-encoders, deep Boltzmann machines, deep belief networks, back-propagations, stochastic gradient descents, Hopfield networks, and radial basis function networks. The model data 137 may include a plurality of models stored in the model data 137 of varying or similar composition or function.

The models stored in the model data 137 may include various properties that may be adjusted and optimized by the corresponding engine during model training. The properties may include any parameter, hyperparameter, configuration, or setting of the model stored in the model data 137. Non-limiting examples of properties may include coefficients or weights of linear and logistic regression models, weights and biases of neural network-type models, cluster centroids in clustering-type models, train-test split ratio, learning rate (e.g. gradient descent), choice of optimization algorithm (e.g., gradient descent, gradient boosting, stochastic gradient descent, Adam optimizer, XGBoost, etc.), choice of activation function in a neural network layer (e.g. Sigmoid, ReLU, Tanh, etc.), choice of value or loss function, number of hidden layers in a neural network, number of activation units (e.g., artificial neurons) in each layer of a neural network, drop-out rate in a neural network (e.g., dropout probability), number of iterations (epochs) in training a neural network, number of clusters in a clustering task, Kernel or filter size in convolutional layers, pooling size, and batch size.

The models stored in the model data 137 may include one or more large language models (LLMs). The LLMs stored in the model data 137 may include various third-party LLMs, APIs for interfacing with one or more third-party LLMs, and/or custom-programmed LLMs. For example, the LLMs stored in the model data 137 may include GPT 3.0, GPT 3.5, GPT 4.0, BERT, Lamda, Llama, and/or any other LLM system.

The output data 138 may include any data generated by the computing environment 101. For example, the output data 138 may include, generated gift cards, generated text, operation logs, failed requests, successful requests, chat logs, requests for more information, and/or any other information generated by the computing environment 101. The data store 111 may store one or more varied success reports. The varied success reports may include requests that initially failed but were later solved through dialogue assistance. As discussed in further detail herein, the computing environment 101 may process the varied success reports to train models and other systems to identify and solve potential issues without the need of added assistance.

Various applications and/or other functionality may be executed in the computing environment 101 according to various examples. Also, various data may be stored in a data store 111 that may be accessible to the computing environment 101. The data store 111 may be representative of one or more of data stores 111 as may be appreciated. The data stored in the data store 111, for example, may be associated with the operation of the various applications and/or functional entities described below.

The components executed on the computing environment 101 may include lists of applications, and other applications, services, processes, systems, engines, or functionality discussed in detail herein. The computing environment 101 may include a management service 113. The management service 113 may function as a centralized computing resource for the computing environment 101. The management service 113 may include a management console 139 and a processing console 141. The management service 113 may perform various computing tasks for the computing environment 101, the client devices 103, and/or any other system distributed across the network 105.

The management console 139 may function as a centralized data management source for the computing environment 101. For example, the management console 139 may store data in the data store 111, distribute data within the computing environment 101, distribute data outside of the computing environment 101, receive data from any particular resource on the network 105, manage a processing address, and/or perform any other particular data management procedure of the computing environment 101. The management console 139 may manage the processing address. The processing address may be an email address, a telephone number, a username for a particular messaging service, a fax machine number, and/or any particular electronic address type capable of receiving electronic communications 127. The username may include an email address or telephone number, such as, for example, for WhatsApp™, Apple iMessage™, or other message delivery system. In one embodiment, the processing address may include messaging mailbox in a video game or a location in a virtual world, such as a location of a particular NPC in a massive multi-player roleplaying game. The processing address may include a particular chat room on a chat server, such as discord. The processing address may include a specific thread or section of a forum. The processing address may receive one or more electronic communications 127 including natural language. The management console 139 may distribute the electronic communication 127 to the processing console 141 for further processing and/or store the electronic communication 127 in the client data 133 of the data store 111.

The processing console 141 may perform any particular computing requirement of the computing environment 101. For example, the processing console 141 may process electronic communications 127, determine the natural language type (e.g., text, speech, video) of the electronic communication 127, extract pertinent information from the electronic communications 127, tokenize a sentence, identify the entity name in a gift card request, identify the gift card amount, identify the recipient, generate the gift card, distribute the gift card, and/or perform any other particular computing requirement of the computing environment 101. The processing console 141 may function as an individual computing system and perform all computing necessities of the computing environment 101, the client devices 103, and/or any other resources distributed across the network 105. The processing console 141 may distribute computing requirements across the network 105 and employ one or more client devices 103 to perform particular processes.

The client device 103 may be representative of a one or more client devices that may be coupled to the network 105. The client device 103 may include, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 103 may include a display 115. The display 115 may include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 103 may include a data store 121. The data store 121 may function as a local iteration of the data store 111. The data store 121 may house the client data 133, private data specific to the client device 103, general local data associated with the client device 103, and/or any other information stored locally on the client device 103. In one example, the data store 121 may house similar data as the data store 111. In another example, the data store 121 may house distinct data from the data stored in the data store 111.

The client device 103 may be configured to execute various applications such as a client application 123 and/or other applications. The client application 123 may be executed in a client device 103, for example, to access network content served up by the computing environment 101 and/or other servers, thereby rendering a user interface on the display 115. To this end, the client application 123 may include, for example, a browser, a dedicated application, etc., and the user interface may include a network page, an application screen, etc. The client device 103 may execute applications beyond the client application 123 such as, for example, email applications, social networking applications, word processors, spreadsheets, and/or other applications.

The client application 123 may function as a dedicated application for submitting gift card requests to the computing environment 101. For example, the client application 123 may function as a stand-alone application with a user interface and other resources. Continuing this example, the client application 123 may interface with the computing environment 101 and send gift card requests submitted by a particular client to the computing environment 101. In another example, the client application 123 may function as a plugin for one or more third-party applications and/or websites. When functioning as a plugin, the client application 123 may mount to a particular application and generate requests for gift cards based on actions performed within the application. For example, the client device 103 may mount the client application 123 as a plugin to Microsoft Outlook™. By mounting the client application 123 to Microsoft Outlook™, the client application 123 may surface as a toolbar widget a text box for textual inputs, an interactive button, and/or any type of interactive system. The client may employ the client application 123 mounted to the particular application to generate requests for one or more gift cards.

The client device 103 may include one or more input devices 125. The input device 125 of the client device 103 may include any device that may generate an input for the client device 103. For example, input devices 125 may include but are not limited to keyboards, microphones, cameras, trackpads, touchscreen displays, a mouse, and/or any other pertinent input device. The input devices 125 may generate inputs for further processing by the computing environment 101. For example, the client device 103 may receive text generated from a keyboard and may send the text to the computing environment 101. In another example, the client device 103 may receive an audio recording from a microphone and may send the audio recording to the computing environment 101 for further processing. In yet another example, the client device 103 may receive a video recording from a camera and send the video recording to the processing console 141 for further processing.

The client device 103 may include one or more electronic communications 127. The electronic communications 127 may define various types of communication formats used to send gift card requests to the computing environment 101. For example, the electronic communications 127 may include but are not limited to text messages, emails, iMessages™, voice recordings, voicemails, forum posts, in-game chats or communications, statements in chat rooms, direct/private messages, social media posts (e.g., Tweets), and/or videos.

Next, a general description of the operation of the various components of the networked environment 100 is provided. The management console 139 may receive the electronic communication 127, where the electronic communication 127 may include natural language. The electronic communication 127 may include, for example, a text message, an email, an iMessage™, a statement in a chat room (e.g., Discord™) a voice recording, a voicemail, a video, and/or any other form of electronic communication 127. In one embodiment, the electronic communication 127 may include a message entered into a chat within a predefined distance from a location in a video game. The chat may correspond to a particular channel of chat. In another embodiment, the electronic communication 127 may include a direct message sent to a particular user or address in a video game or virtual world. The natural language present in the electronic communication 127 may include but is not limited to text, speech, and/or sign language.

The client application 123 may include the user interface for managing, sending, and/or receiving virtual gift cards. The client application 123 may include, for example, a particular user interface that may display the one or more gift cards and the virtual non-human chat assistant. The virtual non-human chat assistant may be a visual representation of a person, a generated voice, and/or any other visual indication that the client device 103 is generating and outputting a particular verbal response. The generated voice for the non-human chat assistant may be generated locally by the computing environment 101. The generated voice for the non-human chat assistant may be generated by an LLM through an API interface.

The management console 139 may receive gift card requests from the client application 123 of the client device 103. For example, the client application 123 may include an extension present in an internet browser. Continuing this example, the client application 123 may include sufficient permissions to monitor one or more activities performed on the client device 103 (e.g., monitoring logs, monitoring mouse movements, monitoring text inputs through a keyboard, screen scraping, monitoring internet activity, monitor voice inputs, etc.). On identifying activities indicating that the client intends to purchase a gift card, the client application may surface an approval request for a particular gift card. For example, when accessing a gift card purchasing page on BestBuy's website, the client application 123 may generate and output a verbal request asking the client if they would like to purchase a gift card of X amount for the following recipient. In another example, the client application 123 may include one or more text boxes. Continuing this example, the client may input a gift card request into the text box. On approval, the client application 123 may send the gift card request to the computing environment 101 for further processing.

The client device 103 may receive the electronic communication 127 in the form of an audio recording input. For example, the client device 103 may output a verbal request through the client application 123 requesting for the user to detail a particular gift card for sending to a recipient. Continuing this example, the client device 103 may record the client's verbal request and process the verbal request in real-time. The client device 103 may employ the LLM to analyze the audio recording input detailing the particular request. The LLM may perform a comparative analysis to determine if the particular request is valid (e.g., there is a particular gift card that satisfies the request, the amount is within a correct range, and/or that the recipient address is correct). The LLM may subsequently generate a response in the form of text or an audio output. The client device 103 may surface the response generated through the LLM via the client application 123 and/or through one or more speakers. The client device 103 may display through the user interface of the client application 123 the selected gift card, the desired amount, and the selected recipient. The client device 103 may subsequently send the gift card to the recipient once the client device receives a second audio recording input detailing an approval of the request.

The client device 103 may record in real-time any particular verbal communication to generate a particular gift card. For example, the client device 103 may, with the permission of the client, may constantly monitor for a prompt that will trigger the client application 123. Continuing this example, the client device 103 may constantly monitor for a trigger prompt that activates the client application 123. On identifying the trigger prompt, the client device 103 may initiate the client application 123 and begin the process of recording the electronic communication 127. In another example, the client device 103 may trigger the client application 123 as a plug-in that interfaces with known virtual assistants (e.g., Siri™) to process and/or receive electronic communications 127.

The management console 139 may receive the electronic communication 127 through the processing address. For example, a client device 103 may send an email requesting one or more gift cards to an email address titled “processing_address@compenvironment.com.” The aforementioned email address may function as the processing address of the management console 139. The management console 139 may adequately store and/or distribute any incoming emails sent to the processing address. For example, an email sent to the processing address may include a message stating, “Please send Larry, at 098-765-4321, a 20 dollar Starbucks™ gift card, and please send Wendy, at 123-456-7890, a 30 dollar Mcdonald's gift card.” The management console 139 may pass the message to the processing console 141 for further processing. Though discussed in the context of an email address, the processing address may also include a phone number. By including a phone number for the processing address, the client device 103 may send gift card requests to the computing environment 101 over text and/or email.

On receiving a request for a gift card, the processing console 141 may determine the format of the electronic communication 127 and the type of natural language present in the electronic communication 127. For example, the processing console 141 may determine the format of the electronic communication 127 by analyzing the file format of the particular request. The processing console 141 may determine the natural language present in the electronic communication 127 by analyzing the contents of the electronic communication 127. For example, the processing console 141 may identify one or more ASCII characters, indicating that the natural language present in the electronic communication 127 includes written text. In another example, the processing console 141 may identify an MP3 file type (e.g., audio recording file type), indicating that the natural language present in the electronic communication 127 is some form of spoken language. In yet another example, the processing console 141 may identify a MP4 file type (e.g., video file type), indicating that the natural language present in the electronic communication 127 is either written text displayed in the video, sign language, or a spoken language. The processing console 141 may employ signal processing techniques to identify the type of natural language present in the video file type and extract any pertinent request made in the video file type.

The processing console 141 may determine request information from the electronic communication by employing speech-to-speech processing techniques. For example, the processing console 141 may determine request information from the audio recording input (e.g., a gift card type, a gift card amount, and/or a gift card recipient) received from the client device 103 by processing the audio recording input through the natural language processing system and/or an LLM. The processing console 141 may subsequently generate a speech-based response to the audio recording input detailing the particular results associated with the requested information.

The processing console 141 may determine the request information by employing a natural language processing model, where the natural language processing model may be with one or more grounding parameters and one or more tuning parameters. For example, the processing console 141 may prompt the natural language processing model to query information from the entity data 135. Based on the entity data 135, the processing console 141 may employ the LLM module to generate responses that are in accordance with the data stored in the entity data 135.

The processing console 141 may employ the LLM to perform speech-to-speech processing, which may include detecting one or more nuances associated with the natural language request. For example, the processing console 141 may employ the LLM to query the entity data 135 to determine any particular differences between the request from the electronic communication 127 and the entity data 135. In another example, the processing console 141 may determine one or more nuances (e.g., one or more specific denotations of the audio recording input) to determine the particular requested information from the audio recording input. In yet another example, the processing console 141 may employ the LLM to determine subtle differences in the enunciation of the client from the audio recording input to determine the exact requested information.

The processing console 141 may determine one or more ambiguities associated with the natural language request from the electronic communication 127, wherein determining the request information comprises resolving the one or more ambiguities. The processing console 141 may employ the LLM to determine particular ambiguities associated with the request detailed in the electronic communication. For example, the electronic communication may include a request for a gift card that is for a painter. The processing console 141 may employ the LLM, which has been trained using the entity data 135, to determine a set of gift cards that are associated with painting. The processing console 141 may generate a response detailing the list of gift cards that are associated with painting and request the user to select one of the gift cards. In another example, the processing console 141 may identify errors associated with a mispronunciation or incorrect naming of a particular attribute of the request. For example, the electronic communication 127 may include an audio recording request requesting a gift card for Amazon™, where the client pronounces “Amazonia”. The processing console 141 may employ the LLM to identify the ambiguity of the mispronunciation and generate a response requesting the client to identify if the Amazon™ was the correct desired gift card.

The processing console 141 may determine if the request information includes translating the audio input into a different language. For example, the electronic communication 127 may include a request to translate the message (e.g., a happy birthday message) for the particular recipient to French. The processing console 141 may employ the LLM by prompting the LLM to translate the particular message in a distinct language (e.g., French).

For natural language in the form of written text, the processing console 141 may preprocess the written text received through the electronic communication 127. The processing console 141 may perform similar processes as those described below for written text for electronic communications 127 in the form of audio recording inputs. For example, the processing console 141 may employ a natural language processing system to process the audio recording input to extract a dialogue in the form of written text. Continuing this example, the processing console 141 may employ the generated written text extracted from the audio recording input (e.g., similarly to an electronic communication 127 including only written text) for further analysis.

The processing console 141 may tokenize each component of the written text. By tokenizing each component of the written text, the processing console may generate a distinct dataset, including one or more sentences, one or more phrases, and/or one or more individual words. The processing console 141 may store the tokenized sentences, phrases, and/or words in distinct data sets within the client data 133 of the data store 111.

The processing console 141 may generate one or more weights for the tokenized words extracted from the electronic communication 127 to determine the contents of the gift card request. For example, using the request, “Please send Larry, at 098-765-4321, a 20 dollar 7 Eleven™ gift card and a 30 dollar McDonald's gift card,” the processing console 141 may generate an initial weight for the numerical values and words present in the gift card request. The processing console 141 may vary the weight of each word and number presented in the gift card request based on their proximity to key terms, the order in which the words and numbers are presented, and other facts associated with the particular sentence structure of the request. For example, the processing console may generate an initial weight for the value “20” and a higher weight for the term “dollar” based on its proximity to the value “20”. Continuing this example, the processing console 141 may generate lower weights for other words in the sentence that are either distant from the value “20” (e.g., “McDonald's gift card”) or unrelated to the value “20” (e.g., the telephone number). Further continuing this example, the processing console 141 may determine, based on the weights associated with the value “20”, that the “20 dollar” gift card is for the store 7 Eleven and not for McDonald's. In another example, the processing console 141 may generate weights based on sentence order to determine particular features of the sentence. The processing console 141 may increase weights for terms that subsequently follow the numerical value of the gift card to determine whether or not the value refers to a currency amount. For example, the processing console 141 may reduce the weight of the word “dollar” prior to the number “7” in “7 Eleven” such that the processing console 141 does not inadvertently identify the amount of the gift card as 7 dollars rather than 20 dollars.

The processing console 141 may compare the tokenized words to the entity data 135 to identify whether or not the entity referenced in the gift card request is present in the entity data 135. For example, the processing console 141 may extract from the electronic communication 127 the entity names for the desired gift cards. The processing console 141 may reference the entity data 135 to identify whether or not the entity is available for gift card generation. In the case that the processing console 141 identifies that the entity is within the entity data 135, the processing console 141 may generate the gift card and send the gift card to the recipient. In the case that the entity requested in the electronic communication 127 is not present in the entity data 135, the processing console 141 may send a follow-up message to the client device 103 requesting for corrected or further information. The processing console 141 may employ one or more natural language processing systems and/or LLMs to identify if the gift card request sent by the client device 103 includes spelling errors. For example, the processing console 141 may train an LLM against the entity data 135 to identify spelling errors associated with the names of various entities. Continuing this example, the processing console 141 may apply the LLM against the gift card request to identify and update any entity names that were misspelled. On identifying a potential misspelling, the processing console 141 may generate, for example, a request sent to the client device 103 stating, “Your initial request stated ‘Aamazzon’, did you intend to write ‘Amazon?’ Please reply ‘yes’ to confirm and ‘no’ to deny.” In another example, the processing console 141 may compare ASCII values of each entity name to the entity data to identify a name with the most similar composition. The processing console 141 may continue to perform a dialogue with the client device 103 until the gift card request is resolved. On resolving the gift card request, the processing console 141 may store the dialogue, logs, and procedures in the output data 138. The processing console 141 may subsequently review the historical gift card request to identify where issues arose in particular communications. For example, the processing console 141 may train one or more machine learning algorithms based on historical gift card requests and employ the machine learning algorithms to generate responses to current gift card requests based on prior requests and known solutions. In another example, the processing console 141 may compare future gift card requests to historical gift card requests to identify if the particular issue has been encountered and, if so, how the processing console 141 resolved the issue. On identifying a similar issue pattern in a current gift card request, the processing console 141 may reuse the historical gift card request to complete the current gift card request.

The processing console 141 may employ one or more natural language processing systems stored in the model data 137 to interpret the request sent by the client device 103. For example, the processing console 141 may vectorize the tokenized words and store the vectorized words in the word embedding libraries of the processing data 131. The processing console 141 may vectorize the tokenized words extracted from the electronic communication by using any particular vectorization algorithm. For example, the processing console may employ the Word2Vec algorithm to generate one or more vectorized words. By storing the vectorized words in the multi-dimensional dataset of the word embedding library, the processing console 141 may employ one or more natural language processing system to identify similarities in the words based on the closeness of one or more words in the vector space. The processing console 141 may further determine the type of request by employing one or more natural language processing systems and analyzing the vector space created from vectorizing the written text extracted from the electronic communication. For example, the processing console 141 may employ the vector space to identify the name of the entity, the amount of the gift card, the recipient of the gift card, and/or the return address of the recipient.

The processing console 141 may employ one or more LLMs to analyze the gift card requests. For example, the processing console 141 may train the LLM using one or more word embedding libraries. The processing console 141 may employ the LLM trained against the word embedding libraries to identify the context of the gift card request, the desired recipient, the desired recipient address, the desired gift card amount, the desired entity name, and/or any other information associated with the gift card request. The processing console 141 may employ the LLMs to generate one or more dialogues with the client device 103 in the case that there's an issue with the particular gift card request.

The processing console 141 may generate a prompt for the LLM to generate a particular response based on the electronic communication 127. For example, the processing console 141 may feed the LLM one or more prompts detailing the entity data 135. The entity data 135 fed to the LLM may include but is not limited to a complete list of all the available gift cards, a description of each gift card and the parent entity, a category for the particular entity, a gift card value range for each gift card, and/or any other pertinent information. The processing console 141 may prompt the LLM to compare the request from the LLM to the entity data 135 to generate a response based on the particular request. For example, if the electronic communication 127 includes a vague request for a particular gift card in a specific field, the processing console 141 may employ the LLM to analyze the request and generate a response detailing various potential options or a request for more information to narrow the particular request. In another example, if the electronic communication 127 includes a request for a specific gift card within the entity data 135, the processing console 141 may employ the LLM to generate a response detailing the successful identification of the gift card and a request to approve the final product. In yet another example, if the electronic communication includes a request for a gift card and there is a particular error present (e.g., the gift card does not exist, the requested amount is not available, etc.), the processing console 141 through the LLM may generate an audio response including an error message detailing the error and a request for information to correct the particular error.

The processing console 141 may employ the LLM to process the electronic communication 127 and generate one or more structured query language (SQL) prompts to query the data store 111 for necessary information. For example, the processing console 141 may employ the LLM to process the electronic communication 127 that may include a particular audio recording input that details the following: “I would like to send my friend, Morgane, a gift card for Sephora™ of 100 dollars. Her cellular number is 123-456-7890. Can you also generate a sentence congratulating her on her graduation from dental school? Thanks!” The processing console 141 may submit the audio recording input to the LLM. The processing console 141 may employ the LLM to generate a textual representation of the audio recording input. The processing console 141 may employ the LLM to generate a SQL query to identify the particular gift card from the entity data 135. The processing console 141 may employ the SQL query to extract visual data representing the gift card from the entity data 135. The processing console 141 may forward the identified visual data and a generated audio response to the client device 103 for displaying through the client application 123 and outputting through the speakers of the client device 103, respectively.

The processing console 141 and/or the client device 103 may generate visual cues in real-time based on the particular electronic communication 127. For example, the processing console 141 may identify, based on the generated SQL query, an image for the particular gift card requested by the client. The processing console 141 may send the image for the particular gift card to the client device 103 for display through the client application 123. Simultaneously while displaying the image for the particular gift card identified from the request by the LLM, the client device 103 may output the particular response through the speakers of the client device 103.

The processing console 141 may generate verbal responses to the electronic communication 127. For example, if the processing console 141 through the LLM identifies an appropriate gift card, the LLM may generate a voice response stating, “Great! We have the Sephora gift card in stock with an acceptable value of 100 dollars. The recipient address also looks correct! Additionally, we've generated the following message you requested, “Keep shining those teeth like the superstar you are! Congratulations” On your approval, we will send the gift card to 123-456-7890.” In another example, the processing console 141 may generate a verbal response that narrows down the particular requested gift cards if the electronic communication 127 does not specify a specific gift card. In yet another example, the processing console 141 may generate an error message detailing that the particular gift card is not available, the amount is outside of the accepted range, the recipient address isn't correct, the billing information in the associated account failed, and/or any particular error associated with the disclosed technology. In yet another example, the processing console 141 through the LLM may adjust any particular request based on subsequent electronic communications 127 received from the client device 103. For example, if the client is unhappy with the message generated by the processing console 141, the processing console 141 may receive a request to adjust the message and subsequently generate an adjusted message through the LLM. The processing console 141 may adjust any particular attribute associated with the original request.

The processing console 141 may evaluate a plurality of available gift cards and rank the gift cards based on relevance to the request information extracted from the electronic communication 127. The processing console 141 may analyze factors such as the requested category, recipient preferences, geographical availability, and/or personalization options associated with the gift cards. For example, if the request information specifies a recipient who enjoys outdoor activities, the processing console 141 may assign higher relevance scores to gift cards associated with brands like REI™ Bass Pro Shops™, or Patagonia™. These scores may be calculated based on a combination of keyword matching, contextual analysis, and learned recipient preferences stored in the client data 133.

To determine relevance, the processing console 141 may apply natural language processing techniques and machine learning algorithms to evaluate the compatibility between the request information and the metadata associated with each gift card. The metadata may include attributes such as merchant category, product offerings, seasonal promotions, and popularity rankings derived from historical purchasing data. For example, a request for a “luxury spa experience” may yield a high relevance score for gift cards from upscale spa chains, whereas gift cards for general wellness products may receive lower scores. The processing console 141 may employ a weighted scoring system, where specific attributes, such as explicitly stated merchant preferences or gift card value range, are prioritized in the relevance calculation.

The ranking process may also incorporate user feedback and historical data to refine the accuracy of the gift card recommendations. For instance, if a particular recipient has historically redeemed gift cards from a specific category, the processing console 141 may adjust its scoring to prioritize gift cards within that category. Additionally, the processing console 141 may leverage collaborative filtering techniques to identify trends among similar users or requests, enabling the processing console 141 to recommend highly relevant gift cards even in cases where explicit preferences are not provided in the request information.

Once the ranking process is complete, the processing console 141 may select and generate a gift card based on their respective rankings (e.g., the highest ranked gift card). According to some aspects, the processing console 141 may generate a ranked list of gift card options to present to the client device 103. The client application 123 may display the ranked gift cards in order of relevance, along with supplemental information such as merchant descriptions, available denominations, and user reviews, allowing the client to make an informed selection. For example, if the request information indicates a budget of $50 and an interest in fitness, the ranked list may include gift cards for fitness apparel, equipment, or gym memberships, with the highest-ranked options most closely aligning with the request parameters. The client may then finalize the selection, and the processing console 141 may proceed with generating and delivering the chosen gift card.

On identifying all the necessary information from the gift card request, the processing console 141 may generate the gift card for the particular recipient. The processing console 141 may create the gift card by charging the client the value of the gift card with an added fee. For example, the client may be charged for the value of the gift card and an additional service fee through an automated transaction process facilitated by the computing environment 101. Upon confirmation of the gift card request, payment information associated with the client (e.g., stored securely within the client data 133 or provided during the transaction) may verified using a payment gateway or a processing service. The service fee, which may be calculated as a fixed amount or a percentage of the gift card value, may be applied to cover operational costs such as transaction processing, infrastructure usage, and/or optional features like personalization or expedited delivery. For example, a $50 gift card may incur a service fee of $2, resulting in a total charge of $52, whereas a premium option may add an additional $1. Once the payment is authorized, the transaction details may be logged in the output data 138 for record-keeping, and the digital gift card may be generated and transmitted to the recipient. If payment authorization fails, the system may generate an error message and request the client to update payment information or adjust the transaction.

On generating the gift card, the management console 139 may distribute a second electronic communication to the recipient address, where the second electronic communication includes all information necessary for redeeming the gift card request. The processing console 141 may employ any particular LLM to generate a message for the recipient. For example, the gift card request may include a request to draft a birthday message to the recipient. On approval by the client device 103. The processing console 141 may include the LLM generated birthday message in the second electronic communication sent to the recipient address.

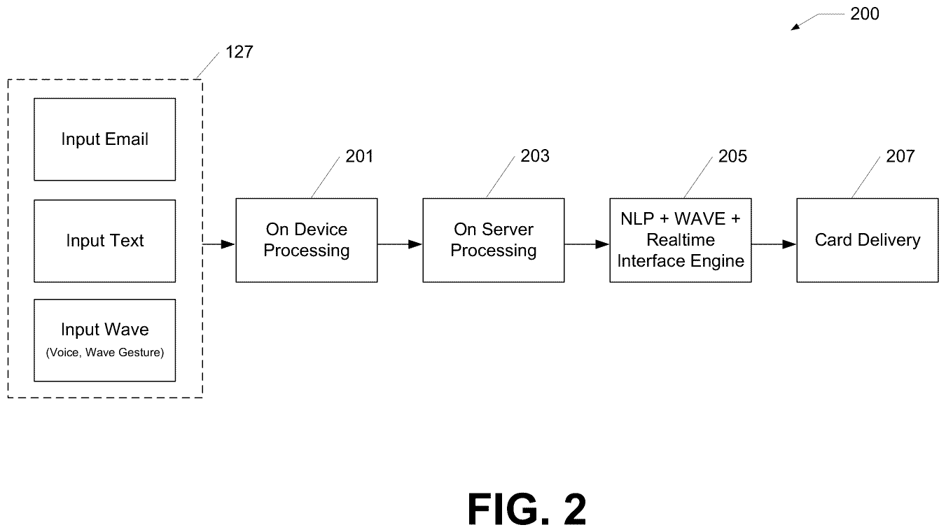

Referring now to FIG. 2, illustrated is a process flow diagram 200 for generating one or more gift cards, according to one example of the present disclosure. The process flow diagram 200 may illustrate a technique for generating one or more electronic communications 127 at the client device 103 and processing the electronic communications 127 at different locations and stages to generate a gift card for a particular recipient.

The client device 103 may generate one or more electronic communications 127. The client application 123 may render a webpage, an email page, a chat page, and/or any other form of communication platform to create and send the electronic communications 127. For example, the client application 123 may render a text box in an email application, where the client may type the gift card request and attach any particular information.

On completion of the electronic communication 127, the client device 103 may perform on-device processing 201. The on-device processing 201 may include correcting any misspelling, referencing local contact information stored on the client device 103 to confirm that the recipient is correctly identified, and pre-identifying the entity of interest. For example, the client application 123 may include a spell checker such that any grammatical errors are corrected prior to the transmission of the electronic communication 127. In another example, the client application 123 may reference the contact information local to the client device 103 to confirm the recipient and their associated information. In another example, the client application 123 may reference the entity data 135. The client application 123 may monitor the creation of the electronic communication 127 and may identify in real-time if the entity is present in the entity data 135. On identifying that the entity as written in the electronic communication 127 is not in the entity data 135, the client application 123 may surface one or more suggested corrections for the particular entity. If the client application 123, performing similar functionalities as the processing console 141, may not identify the entity prior to the completion of the gift card request, the client application 123 may surface a notification on the client device 103 that the entity as written could not be identified or is unavailable.

Once the gift card request is completed, the client device 103 may send the electronic communication 127 to the computing environment 101 for on-server preprocessing 203. The computing environment 101 may preprocess the electronic communication 127 by identifying the electronic communication type, identifying the natural language type, tokenizing one or more sentences, phrases, and/or words, generating various weights for various words, vectorizing one or more of the tokenized words, and correcting any pre-known issues identified in the electronic communication 127. The processing console 141 may perform the on-server preprocessing 203 such that the gift card request may be processed using any particular model stored in the model data 137.

The processing console 141 may perform natural language processing procedures 205 on the processed gift card request. The processing console 141 may employ one or more natural language processing techniques discussed herein to identify the requested value of the gift card, the entity of the gift card, the desired recipient of the gift card, and any other information present in the gift card request. The processing console 141 may perform the analyses in real-time such that the gift card may either be sent out to the recipient if no issues are detected or analyzed to determine the particular issue present in the gift card request. In the presence of an issue, the processing console 141 may employ one or more machine learning models to analyze past successful gift card requests. On identifying a successful gift card request that includes the same identified issue, the processing console 141 may employ similar techniques to resolve the current gift card request. The processing console 141 may store all successful and unsuccessful transactions in the output data 138 for further processing.

On successfully identifying all prerequisite information, the processing console 141 may perform a gift card generation procedure 207. The processing console 141 may generate the gift card and send the gift card to the recipient address. The processing console 141 may generate, using one or more LLMs stored in the model data 137, a desired message for the recipient as requested in the gift card request from the client device 103. The processing console 141 may send the generated message and the gift card to the recipient address.

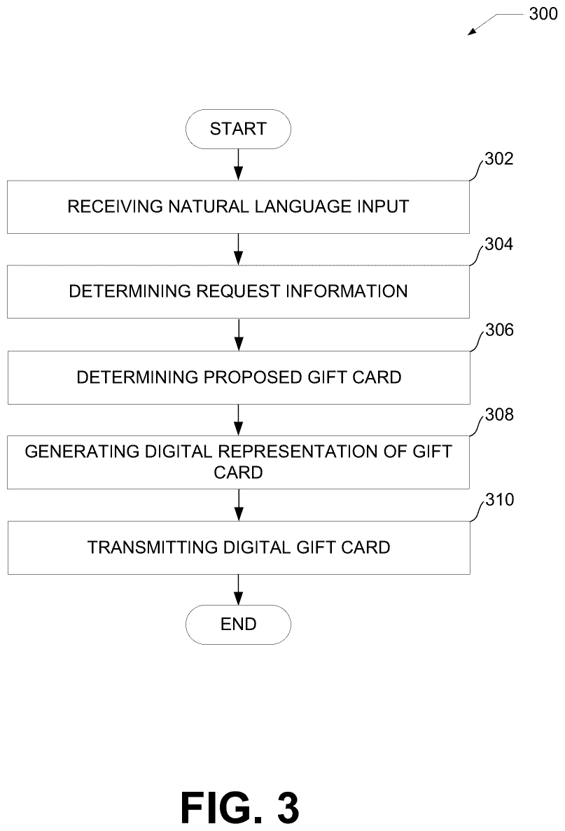

Referring now to FIG. 3, illustrated is a flowchart of a process 300, according to one example of the disclosed technology. The process 300 may illustrate a technique for generating the requested gift card for a particular recipient. Any particular system distributed across the networked environment 100 may perform the process 300. For example, the process 300 may be performed by the computing environment 101, the client device 103, and/or any other particular device with like capabilities.

At box 302, the process 300 may include receiving an audio input including a natural language request from a user for a digital gift card. The processing console 141 and/or the client device 103 may receive an audio recording input in the form of the electronic communication 127 including the natural language request from the user for the digital gift card. For example, the user may speak into the client device 103 after the client device 103 requests a gift card selection through the client application 123. The client device 103 may record the user's speech through the input device 125 and may send the audio recording input in the form of the electronic communication 127 to the processing console 141.

At box 304, the process 300 may include determining request information based on the audio input. The request information may include but is not limited to one or more user preferences associated with the request (e.g., requesting language type, requesting message length, requesting gift card image color, etc.), recipient information associated with the recipient device, the name of the gift card, one or more desired messages, the gift card amount, and/or any other pertinent information associated with the request. The processing console 141 may determine request information based on the audio recording input. For example, the processing console 141 may employ one or more natural language processing systems to convert the audio input into written text and extract the request information from the written text. In another example, the processing console 141 may employ the LLM to extract the request information from the audio recording input, the written text, and/or any form of the electronic communication 127. The processing console 141 may prompt the LLM to extract information such as the requested gift card, the entity name, the desired message (if any), the requested amount, recipient associated information, and/or any other information associated with the audio recording input. For example, the processing console 141 may determine a personalized message based on contextual information extracted from the natural language request (e.g., the request included a statement requesting the computing environment 101 to generate a happy graduation message).

At box 306, the process 300 may include determining, by querying a database of available gift cards, a proposed gift card based on the request information. The processing console 141 may determine, by querying the entity data 135 (e.g., the database of available gift cards), the proposed gift card based on the request information. The processing console 141 may prompt the LLM to generate a query to search the entity data 135 for the specified gift card in the request information. The processing console 141 may return whether or not the gift card is included in the query data. If the gift card is included in the entity data 135, the processing console 141 may prompt the LLM to generate a speech response indicating that the gift card is available. If the gift card is not included in the entity data 135, the processing console 141 may prompt the LLM to generate a response indicating that the gift card is unavailable and make a subsequent request for a new gift card. The processing console 141 may receive an updated response based on the failed or vague request from the original request information and generate an updated query based on the updated request information from the updated response.

At box 308, the process 300 may include generating a digital representation of the proposed gift card. The processing console 141 may generate a digital representation of the proposed gift card. The processing console 141 on identifying the correct and available gift card for the recipient may surface through a user interface of the client application a digital rendition of the gift card, the proposed message, the amount of the gift card, and the recipient's address.

At box 310, the process 300 may include transmitting the digital representation of the gift card to a recipient device. The processing console 141 may transmit the digital representation of the gift card to the recipient client device 103. The processing console 141 may send the digital representation of the gift card as an email, an SMS, an iMessage, and/or any other form of digital communication to the recipient's client device 103.

From the foregoing, it will be understood that various aspects of the processes described herein are software processes that execute on computer systems that form parts of the system. Accordingly, it will be understood that various examples of the system described herein are generally implemented as specially-configured computers including various computer hardware components and, in many cases, significant additional features as compared to conventional or known computers, processes, or the like, as discussed in greater detail herein. Examples within the scope of the present disclosure also include computer-readable media for carrying or having computer-executable instructions or data structures stored thereon. Such computer-readable media may be any available media which may be accessed by a computer, or downloadable through communication networks. By way of example, and not limitation, such computer-readable media may comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which may be used to carry or store computer program code in the form of computer-executable instructions or data structures and which may be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the examples of the claimed innovations may be described in the context of computer-executable instructions, such as program modules or engines, as described earlier, being executed by computers in networked environments. Such program modules are often reflected and illustrated by flow charts, sequence diagrams, example screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Examples of the claimed innovation are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A client may enter commands and information into the computer through keyboard, touch screen, pointing device, a script containing computer program code written in a scripting language, or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the innovations are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the innovation is connected to the local network through a network interface or adapter. When used in a WAN or WLAN networking environment, the computer may include a modem, a wireless link, or other mechanisms for establishing communications over the wide-area network, such as the Internet. In a networked environment, program modules depicted relative to the computer, or portions thereof, may be stored in a remote data storage device. It will be appreciated that the network connections described or shown are example and other mechanisms of establishing communications over wide area networks or the Internet may be used.

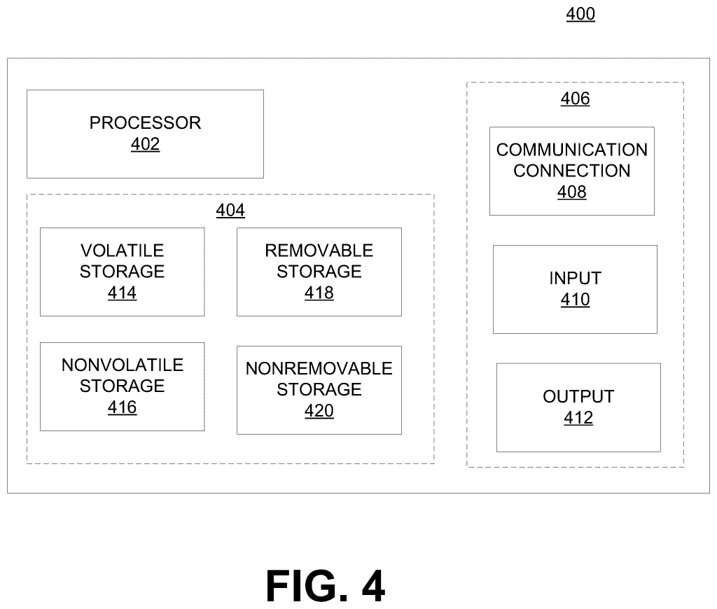

FIG. 4 is a block diagram of a computing device 400 that may be connected to or comprise a component of environment 100. Computing device 400 may comprise hardware or a combination of hardware and software. The functionality to generate gift cards may reside in one or a combination of computing devices 400. Computing device 400 depicted in FIG. 4 may represent or perform functionality of an appropriate computing device 400, or a combination of computing devices 400, such as, for example, a component or various components of a gift card generation system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 4 is exemplary and not intended to imply a limitation to a specific example or configuration. Thus, computing device 400 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 400 may comprise a processor 402 and a memory 404 coupled to processor 402. Memory 404 may contain executable instructions that, when executed by processor 402, cause processor 402 to effectuate operations associated with gift card generation. As evident from the description herein, computing device 400 is not to be construed as software per se.

In addition to processor 402 and memory 404, computing device 400 may include an input/output system 406. Processor 402, memory 404, and input/output system 406 may be coupled together (coupling not shown in FIG. 4) to allow communications between them. Each portion of computing device 400 may comprise circuitry for performing functions associated with each respective portion. Thus, each portion may comprise hardware, or a combination of hardware and software. Accordingly, each portion of computing device 400 is not to be construed as software per se. Input/output system 406 may be capable of receiving or providing information from or to a communications device or other network entities configured for gift card generation. For example, input/output system 406 may include a wireless communication (e.g., 3G/4G/5G/GPS) card. Input/output system 406 may be capable of receiving or sending video information, audio information, control information, image information, data, or any combination thereof. Input/output system 406 may be capable of transferring information with computing device 400. In various configurations, input/output system 406 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 406 may comprise a Wi-Fi finder, a two-way GPS chipset or equivalent, or the like, or a combination thereof.

Input/output system 406 of computing device 400 also may contain a communication connection 408 that allows computing device 400 to communicate with other devices, network entities, or the like. Communication connection 408 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 406 also may include an input device 410 such as keyboard, mouse, pen, voice input device, or touch input device. Input/output system 406 may also include an output device 412, such as a display, speakers, or a printer.

Processor 402 may be capable of performing functions associated with generating gift cards, such as functions for distributing gift cards by interpreting natural language in electronic communications, as described herein. For example, processor 402 may be capable of, in conjunction with any other portion of computing device 400, facilitating various functions for the generating one or more gift cards by interpreting natural language in an electronic communication and sending the gift cards to one or more recipients, as described herein.

Memory 404 of computing device 400 may comprise a storage medium having a concrete, tangible, physical structure. As is known, a signal does not have a concrete, tangible, physical structure. Memory 404, as well as any computer-readable storage medium described herein, is not to be construed as a signal. Memory 404, as well as any computer-readable storage medium described herein, is not to be construed as a transient signal. Memory 404, as well as any computer-readable storage medium described herein, is not to be construed as a propagating signal. Memory 404, as well as any computer-readable storage medium described herein, is to be construed as an article of manufacture.

Memory 404 may store any information utilized in conjunction with gift card generation. Depending upon the exact configuration or type of processor, memory 404 may include a volatile storage 414 (such as some types of RAM), a nonvolatile storage 416 (such as ROM, flash memory), or a combination thereof. Memory 404 may include additional storage (e.g., a removable storage 418 or a non-removable storage 420) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 400. Memory 404 may comprise executable instructions that, when executed by processor 402, cause processor 402 to effectuate operations associated with generating gift cards.

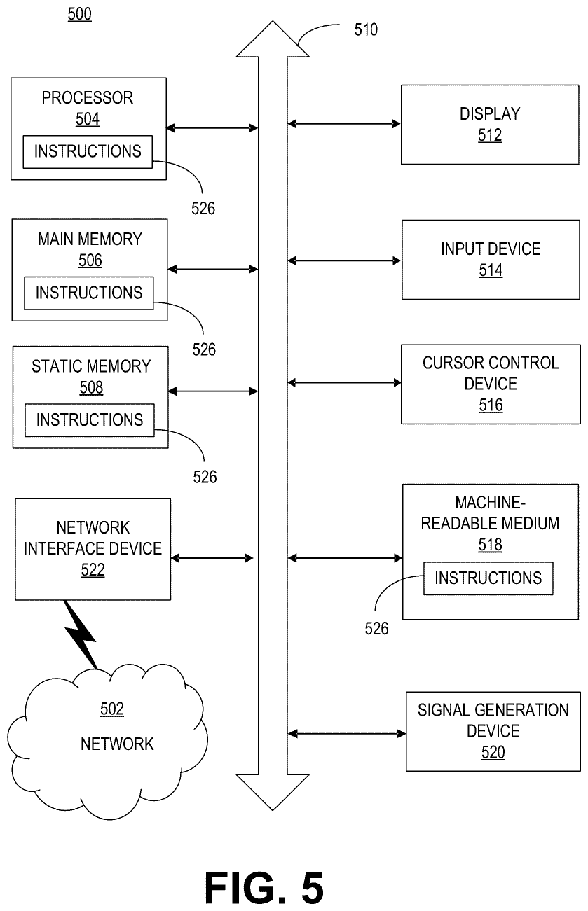

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 402, computing environment 101, client device 103, data store 111, and other devices of FIGS. 1-4. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., instructions 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

While examples of a system for generating gift cards have been described in connection with various computing devices/processors, the underlying concepts may be applied to any computing device, processor, or system capable of distributing gift cards by interpreting natural language in electronic communications. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for gift card generation. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with generating gift cards as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing P2P fantasy sports contests as described herein. When implemented on a general-purpose processor, the program code combines with the processor to provide a unique device that operates to invoke the functionality of distributing gift cards by interpreting natural language in electronic communications.

While the disclosed systems have been described in connection with the various examples of the various figures, it is to be understood that other similar implementations may be used, or modifications and additions may be made to the described examples of systems for gift card generation without deviating therefrom. For example, one skilled in the art will recognize that a gift card generation system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

While various aspects have been described in the context of a preferred example, additional aspects, features, and methodologies of the claimed innovations will be readily discernible from the description herein, by those of ordinary skill in the art. Many examples and adaptations of the disclosure and claimed innovations other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed innovations. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed innovations. In addition, some steps may be carried out simultaneously, contemporaneously, or in synchronization with other steps.

The examples were chosen and described in order to explain the principles of the claimed innovations and their practical application so as to enable others skilled in the art to utilize the innovations and various examples and with various modifications as are suited to the particular use contemplated. Alternative examples will become apparent to those skilled in the art to which the claimed innovations pertain without departing from their spirit and scope. Accordingly, the scope of the claimed innovations is defined by the appended claims rather than the foregoing description and the example examples described therein.

What is claimed is:

1. A method performed by one or more computing devices, the method comprising:
receiving an audio input comprising a natural language request from a user for a digital gift card;
determining request information based on the audio input;
determining, by querying a database of available gift cards, a proposed gift card based on the request information;
generating a digital representation of the proposed gift card; and
transmitting the digital representation of the digital gift card to a recipient device.

2. The method of claim 1, wherein the determining the request information comprises querying a large language model.

3. The method of claim 1, wherein determining the request information comprises speech-to-speech processing.

4. The method of claim 1, wherein the request information is determined by a natural language processing model and the natural language processing model is trained with one or more grounding parameters and one or more tuning parameters.

5. The method of claim 4, wherein the speech-to-speech processing comprises detecting one or more nuances associated with the natural language request.

6. The method of claim 1, further comprising determining one or more ambiguities associated with the natural language request, wherein determining the request information comprises resolving the one or more ambiguities.

7. The method of claim 1, wherein determining the request information comprises translating the audio input into a different language.

8. The method of claim 1, further comprising determining a personalized message based on contextual information extracted from the natural language request.

9. The method of claim 1, wherein the request information comprises one or more user preferences.

10. The method of claim 1, wherein the request information comprises recipient information associated with the recipient device.

11. The method of claim 1, further comprising generating a visual or audio interface comprising instructions associated with the natural language request.

12. The method of claim 1, wherein determining the proposed gift card comprises matching a gift card type associated with the request information with an available gift card of the available gift cards.

13. The method of claim 1, further comprising ranking a plurality of available gift cards based on relevance to the request information.

14. The method of claim 1, further comprising receiving feedback associated with the proposed gift card and updating the query to the database of available gift cards based on the feedback.

15. The method of claim 1, further comprising verifying recipient information associated with the recipient device, wherein the digital representation of the digital gift card is transmitted to the recipient device based the verification of the recipient information.

16. The method of claim 1, wherein the digital representation of the digital gift card comprises a personalized message.

17. The method of claim 1, wherein the digital representation of the digital gift card is transmitted via email, SMS, or a messaging application.

18. The method of claim 1, further comprising transmitting a confirmation message to the user.

19. One or more computing devices, comprising one or more processors, configured to:
receive an audio input comprising a natural language request from a user for a digital gift card;
determine request information based on the audio input;
determine, by querying a database of available gift cards, a proposed gift card based on the request information;
generate a digital representation of the proposed gift card; and
transmit the digital representation of the digital gift card to a recipient device.

20. A system comprising:
one or more processors; and
memory coupled with the one or more processors, the memory storing executable instructions that when executed by the one or more processors cause the one or more processors to effectuate operations comprising:
receiving an audio input comprising a natural language request from a user for a digital gift card;
determining request information based on the audio input;
determining, by querying a database of available gift cards, a proposed gift card based on the request information;
generating a digital representation of the proposed gift card; and
transmitting the digital representation of the digital gift card to a recipient device.
